(19) United States
(12) Patent Application Publication
(10) Pub. No.: US 2002/0013802 A1
(43) Pub. Date: Jan. 31, 2002

(54) Resource allocation method and system for virtual computer system

(76) Inventors: Toshiaki Mori, Hachioji (JP); Yasuo Yamasaki, Kodaira (JP)

Correspondence Address: Mattingly, Stanger & Malur, P.C., 104 East Hume Avenue, Alexandria, VA, 22301, US

(21) Appl. No.: 09/808,951

(22) Filed: Mar. 16, 2001

(30) Foreign Application Priority Data
Jul. 26, 2000 (JP) 2000-231346

(51) Int. Cl. G06F 17/00; G06F 9/00

(52) U.S. Cl. 709/1

(57) ABSTRACT

A virtual machine system which forms a hot standby configuration in a single computer system and effectively controls plural operating systems and application programs, and a method of allocating resources in the virtual machine system. Plural operating systems are initiated with a small amount of main storage allocated to the individual operating systems, whereby the fixed amount of main storage allocated is reduced. When an application program is executed, a request to extend a resource is issued to a virtual machine monitor to obtain the resource, whereby an operating system newly allocates the resource to execute the application program. Where a hot standby system is built using the virtual machine system, resources are reused by reallocating resources of the active operating system to a standby operating system.

### BACKGROUND OF THE INVENTION

1. Field of the Invention

The present invention relates to a computer system, and more particularly to a method of distributing computer resources to plural OSs in a computer system in which the OSs operate on one computer.

2. Description of the Prior Art

There is a virtual machine system (VMS) as a system in which plural operating systems (OS) on one computer system are executed. The virtual machine system logically splits processors, main storage, auxiliary memory, communication controllers, and other physical resources which belong to the computer system, to create plural logical virtual machines (VM) in each of which a different OS can be run.

There is also a virtual machine system that has the function to rapidly save and restore the statuses of virtual machines with the aid of hardware features such as a processor resource management feature (PRMF). Both of the virtual machine systems logically split resources of physically one computer system to enable plural OSs to be run.

An object of using a virtual machine system is to increase the operability of one computer system by running different types of OSs, OSs of different settings, or OSs of different versions.

A first method of the auto-operation for coupled multi-system as described below is available as a method of improving the operability of a computer system. According to the first method of the auto-operation for coupled multi-system, a virtual machine system is logically split into plural virtual machines in each of which an active OS and a standby OS are run on one computer system, and system switching is automatically performed. Namely, an active VM and a standby VM are provided.

The first prior art auto-operation method, without taking main storage capacity used by the OS in a hot standby system into account, allocates a fixed, same amount of main storage to both of the standby OS and the active OS, posing the problem that, since resources used by application programs to operate are allocated to the standby OS, the resources used not all times are useless.

Also, the first prior art auto-operation method requires, even in a single virtual computer system, that a system switching device for monitoring the operation of each OS be connected to each OS of a dual system to create a hot standby system.

A method of dynamically allocating main storage to virtual machines is described in, e.g., Japanese Unexamined Patent Publication No. Hei 6-110715. Namely, depending on an operation time zone of each OS and each system fault, a predetermined main storage area can be reallocated to each VM upon occurrence of an event.

The second prior art method of dynamically reallocating main storage has a problem in that execution of an active OS and a standby OS in an identical virtual machine system is not taken into account, and resources of one OS cannot be reallocated to another OS unless both OSs operate normally.

Also, the second prior art method of dynamically reallocating main storage, without taking into account a main storage capacity for suitably reexecuting application programs operating on each virtual machine, may alter a main storage capacity allocated to a VM regardless of the resource of a failing application program (more resources may be reallocated than the resources used by the failing application program). Therefore, it has the problem of interfering with execution of other application programs operating on an identical OS.

### SUMMARY OF THE INVENTION

An object of the present invention is to effectively allocate resources to an active OS (active VM) and a standby OS (standby VM) in a hot standby system employing an identical virtual machine system, thereby to increase the execution speed of user applications operating on the active OS.

Another object of the present invention is to decrease resources required in a hot standby system.

Still another object of the present invention is to provide a virtual machine system that, when a fault occurs in a hot standby system employing an identical virtual machine system, effectively switches application programs operating on an active OS to a standby OS.

A typical characteristic of the present invention is a resource allocation method that decreases resources allocated to a standby OS and increases resources allocated to an active OS, thereby to allocate more resources to application programs operating on the active OS.

To be more specific, the active OS calculates resources required each time an application program is initiated, and if resources owned by it are insufficient, contacts a virtual machine monitor for resource extension.

Another characteristic of the present invention is a resource allocation method that, upon detection of abnormal stop of the active OS, deallocates resources having been used by the active OS, and allocates the resources to the standby OS.

Another characteristic of the present invention is a resource allocation method that keeps track of uses of a main storage area allocated to the active OS, and when an application program operating on the active OS stops abnormally, reallocates the main storage area to the standby OS according to uses kept track of, thereby to reexecute the application program on the standby OS.

Other characteristics of the present invention will become apparent from a detailed description of an embodiment.

### BRIEF DESCRIPTION OF THE DRAWINGS

A preferred embodiment of the present invention will be described in detail based on the followings, wherein:

FIG. 1 is a conceptual diagram showing the software structure of an embodiment of the present invention;

FIG. 2 is a block diagram showing the hardware structure of the embodiment;

FIG. 3 is a block diagram showing the system structure in which a hot standby application is run on an active operating system of the embodiment;

FIG. 4 illustrates a resource management table of the embodiment;

FIG. 5 is a flowchart showing resource reallocation processing when a fault occurs in an active OS; and

FIG. 6 is a flowchart showing the process of resource reallocation when a hot standby application program fails.

### DETAILED DESCRIPTION OF THE PREFERRED EMBODIMENTS

In an embodiment of the present invention, when an active OS (OS operating on an active VM) is operating normally, more resources are allocated to the active OS than to a standby OS. The active OS calculates resources required and allocates them each time an application program is initiated, and if resources owned by it are insufficient, contacts a virtual machine monitor for resource extension.

Upon detection of abnormal stop of the active OS, the system deallocates resources having been used by the active OS and allocates the resources to a standby OS (OS operating on a standby VM).

Furthermore, the system keeps track of uses of a main storage area allocated to the active OS (active VM), and when an application program operating on the active OS stops abnormally, reallocates the main storage area to the standby OS (standby VM) according to uses kept track of, thereby to reexecute the application program on the standby OS.

Hereinafter, an embodiment on a method of allocating resources in a virtual machine of the present invention will be described in detail with reference to the accompanying drawings.

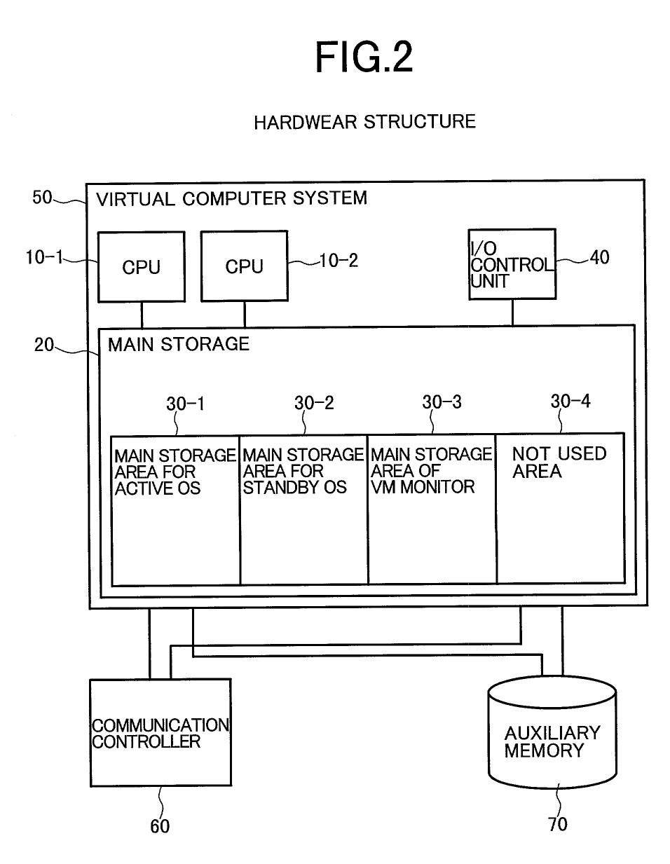

FIG. 2 shows a hardware structure of a virtual machine system (VMS) in the present invention.

A virtual computer system 50 is a computer system that comprises one or more CPUs 10-1 and 10-2, a main storage 20, and an I/O control unit 40. A communication controller 60 and an auxiliary memory 70 are connected to the virtual computer system 50.

The CPUs 10 are processors that interprets and executes instruction words stored in the main storage 20. The main storage 20 is a storage unit for supplying programs and data to the CPUs 10-1 and 10-2. The I/O control unit 40 is a unit for transferring programs and data between the auxiliary memory 70 or communication controller 60 and the main storage 20. The auxiliary memory 70 is a nonvolatile recording device that stores programs and data. The communication controller 60 is a control device for transferring data to other computer systems over communications. In the virtual computer system 50, for the purpose of management by software or firmware to manage virtual machines, the main storage 20 is split into a main storage area for active OS (active OS area) 30-1, a main storage area for standby OS (standby OS area) 30-2, a main storage area of virtual machine monitor 30-3 for managing the virtual computer system 50, and a not-used area 30-4.

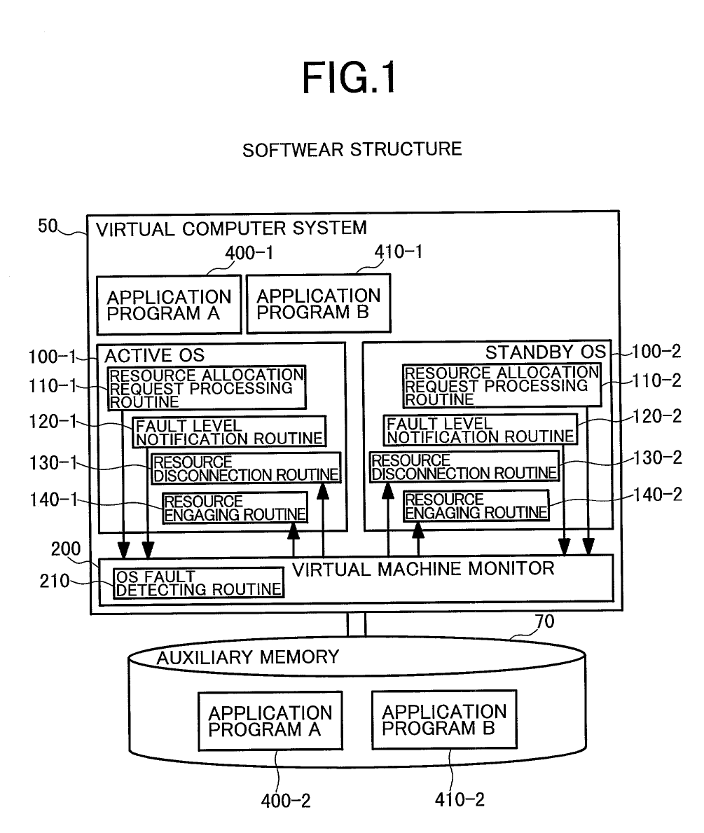

FIG. 1 shows the software structure of a virtual machine system (VMS) of the present invention.

In a virtual computer system 50, the following software modules are operating: a virtual machine monitor 200 for managing resources of the computer system; an active operating system (active OS) 100-1 controlling the execution of application programs A400-1 and B410-1, based on resources allocated by the virtual machine monitor 200; and a standby operating system (standby OS) 100-2 that allocates resources to an application program A400-2 or B410-2 stored in an auxiliary memory 70 and executes them when the active OS fails. The active OS 100-1 and the standby OS 100-2 may or may not be an OS of a same strain. Where the active OS 100-1 and the standby OS 100-2 are OSs of a same strain, the application programs A400-1 and A400-2 maybe the same (at least programs to perform a similar application). Likewise, the application programs B410-1 and B410-2 may be the same (at least programs to perform a similar application).

In short, the application program A400-2 is a hot standby program of the application program A400-1, and the application program B410-2 is a hot standby program of the application program B410-1.

The virtual machine monitor 200 manages resources of the virtual computer system 50. To be more specific, the virtual machine monitor 200 manages the active OS 100-1 and the standby OS 100-2 operating on the virtual machine system; assigns CPUs 10-1 and 10-2 for executing the application programs A400-1 and B400-1; manages a main storage 20 in a specific assignment unit; and manages an area for active OS 30-1, an area for standby OS 30-2, an area of virtual machine monitor 30-3, and a not-used area 30-4.

The CPU 10-1 and 10-2 under control of the virtual machine monitor 200 may be assigned by a method as described in Japanese Unexamined Patent Publication No. Hei 9-26889. Namely, an OS has means, according to a change of external conditions, for issuing a command specifying a specific VM to change the amount of processor assignment, and a virtual machine control program changes the amount of processor assignment of the specified VM.

In the present invention, the virtual machine monitor 200 has an OS fault detection routine 210 that detects an abnormal condition of the active OS 100-1 and the standby OS 100-2, which are operating systems operating on the virtual computer system 50. The OS fault detection routine 210 detects faults in a manner that detects that the CPU 10-1 or 10-2 is in a specific state (e.g., processing stalls) during execution of the active OS 100-1 or standby OS 100-2.

The active OS 100-1 has: a resource allocation request processing routine 110-1 that calculates resources required to execute the application program A400-1 and asks the virtual machine monitor 200 for resource extension if resources owned by the active OS 100-1 are insufficient; a fault level notification routine 120-1 that, when a fault occurs in the application programs A400-1 and B410-1, notifies the virtual machine monitor 200 of the level of the fault; a resource disconnection routine 130-1 that deallocates resources owned by the active OS 100-1 upon a request from the virtual machine monitor 200; and a resource engaging routine 140-1 that enables resources allocated to the active OS 400-1 upon a request from the virtual machine monitor 200. Likewise, the standby OS 100-2 also has: a resource allocation request processing routine 110-2; a fault level notification routine 120-2; a resource disconnection routine 130-2; and a resource engaging routine 140-2.

Hereinafter, functions in the present invention will be described.

First, a description will be made of a method of allocating a resource to the application program A400-1 by the resource allocation request processing routine 110-1 that requests resource extension of the active OS 100-1. As a concrete example of the method, a method is described which allocates an area 80-1 used by the application program A to the application program A 400-1 from an area of the main storage 20. Although the description uses the main storage 20 as an example, the auxiliary memory 70 can also be treated as a resource.

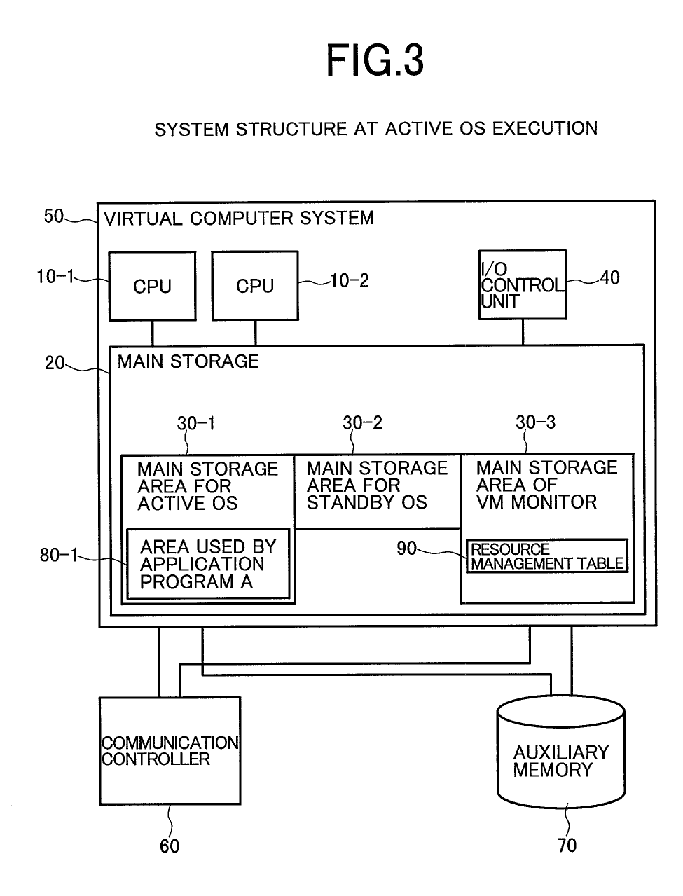

FIG. 3 shows a system structure when the application program A 400-1 is operating on the active OS 100-1. The area 80-1 used by the application program A, which is a part of a main storage area on the main storage 20, allocated for management of the active OS 100-1, stores a program, data, and dynamic execution information of the application program A400-1. A resource management table 90 is a table for managing the purposes of using the main storage 20 and is in an area 30-3 managed by the virtual machine monitor.

In allocating the area 80-1 used by the application program A, for execution of the application program A400-1, the active OS 100-1, from job control parameters, system parameters, user's environment variables, and other information, detects that the application program A400-1 is a job (hereinafter simply referred to as a hot standby job) that operates on the active OS 100-1 and is switched to the application program A400-2 on the standby OS 100-2 when a fault occurs, calculates a resource amount used by the application program for execution, and compares it with a resource amount owned by the active OS 100-1 to determine whether resources are sufficient.

If resources are sufficient, the active OS 100-1 notifies the virtual machine monitor 200 of what resource is in use, through the resource allocation request processing routine 110-1. Where resources are insufficient, the active OS 100-1 obtains a new resource from the virtual machine monitor 200 through the resource allocation request processing routine 110-1. By the resource allocation request processing routine 110-1, the virtual machine monitor 200 records the area 80-1 used by the application program A400 and information for managing it in the resource management table 90. The virtual machine monitor 200 may allocate resources to the active OS 100-1 using the method described in Japanese Unexamined Patent Publication No. Hei 6-110715. The Japanese Unexamined Patent Publication No. Hei 6-110715 describes that an area at a high-order address of a guest area of the VM to be extended is placed into an unconnected state before being placed into a connected area of the VM, thereby to extend an area. The active OS 100-1 can allocate resources to the application program A400-1 in a manner that splits and allocates the resources from the area 80-1 used by the application program A.

The active OS 100-1 operating on a conventional virtual machine splits and manages resources allocated by the virtual machine monitor 200, and allocates apart of the resources during execution of the application program A400-1. Specifically, the application program A400-2 stored on the auxiliary memory 70 is expanded onto an area 30-1 allocated to the OS 100-1 and executed by the CPUs 10-1 and 10-2.

The active OS 100-1 in the present invention, before executing the application program A400-1, determines whether resources owned by the active OS 100-1 are sufficient, and if they are insufficient, asks the virtual machine monitor 200 for resource extension. The virtual machine monitor 200 arbitrates resource allocation between virtual machines, and as a result, if the active OS 100-1 is allowed for resource extension, adds a part of resources owned by the virtual machine monitor 200 to the active OS 100-1. Thereby, the application program A400-1 obtains a suitable resource on the active OS 100-1 and becomes executable.

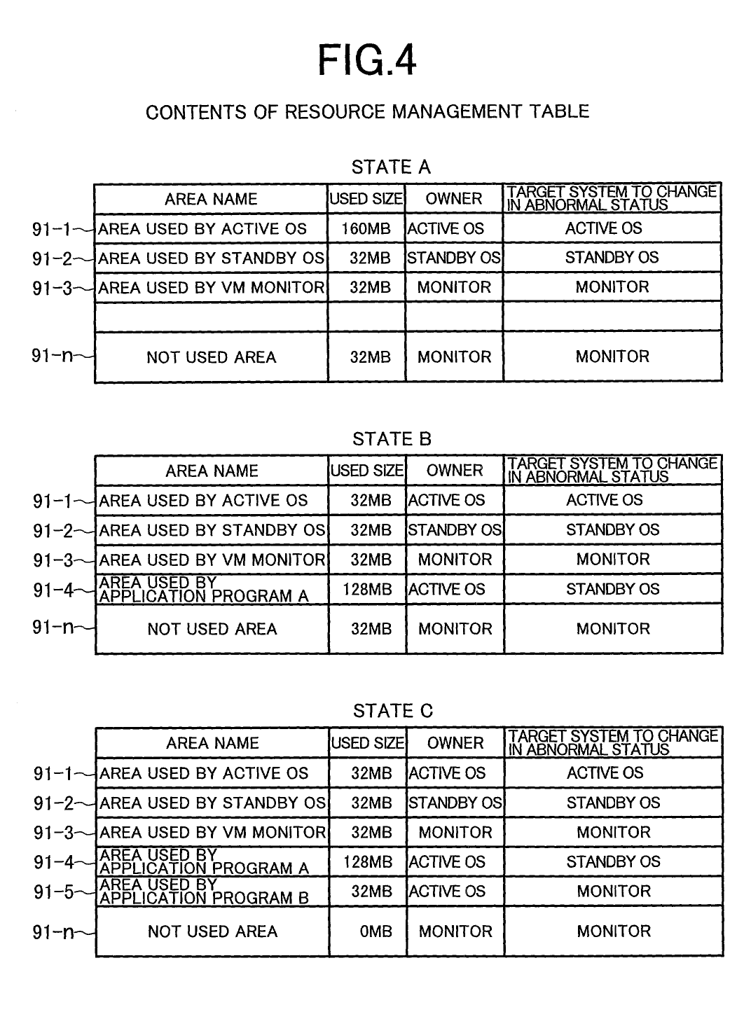

FIG. 4 shows the structure of the resource management table 90 and state transition of the table during application program execution. State A designates a state in which no application program is executed; state B designates a state in which the application program A, a hot standby job, is executed; and state C designates a state in which the application program B, not a hot standby job, is executed in the state B. The resource management table 90 comprises entries 91-1, 91-2, 91-3, and 91-n in each of which an area name for identifying an individual area, used size, owner, and resource switching destination in abnormal status are recorded.

Not all application programs are continued to execute in a standby system when a fault occurs in an OS. Only predetermined, important application programs are continued to execute under control of the standby OS. If a fault occurs in an OS, processing other than predetermined application programs is stopped, and areas used for the processing are returned to a virtual machine monitor. If a fault occurs only in an important application program, the application program is continued to execute under control of a standby OS and other application programs are continued to execute under control of an active OS.

In a change from state A to state B, 160 MB is initially allocated to the active OS 100-1, and when the hot standby application program A400-1 using a resource of 128 MB is executed, in the resource management table, 128 MB is subtracted from the used size of the active OS, and a switching destination OS is defined for the hot standby application program.

In a change from state B to state C, the active OS 100-1 holds no sufficient resources to execute the application program B. Therefore, the active OS 100-1 issues a resource allocation request to the virtual machine monitor 200 to secure an area not used in the virtual machine system, thereby to run the application program B on the active OS 100-1. The target system to change in abnormal status indicates to which area to reallocate the resources of the active OS 100-1 or the application program A 400-1 when they stop abnormally.

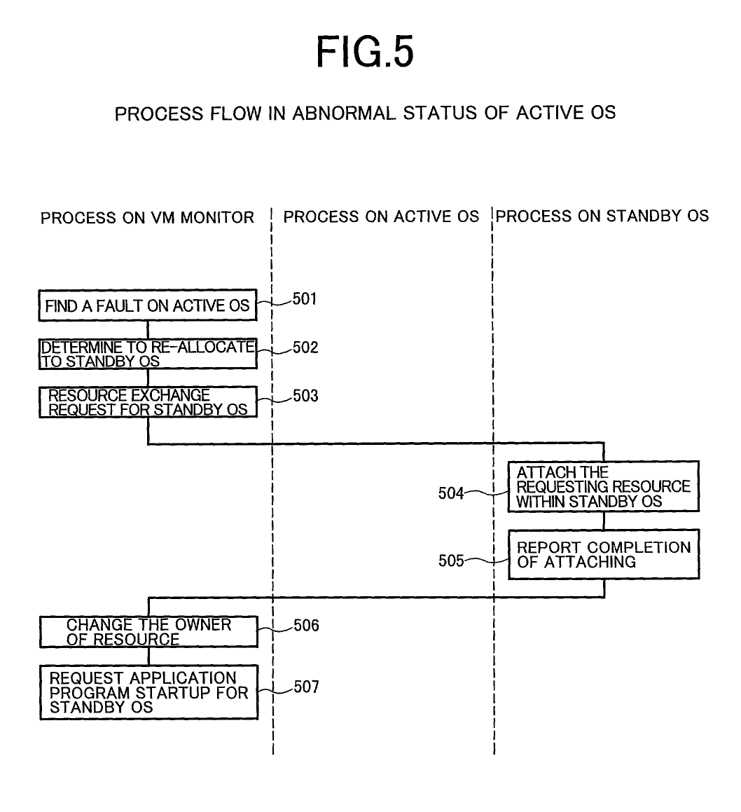

Next, referring to FIG. 5, the resource engaging routine 140-2 is described using, as an example, a processing flow when the active OS 100-1 fails. The virtual machine monitor 200 detects a fault of the active OS 100-1 by the OS fault detecting routine 210 (step 501), determines where to reallocate a resource owned by the active OS 100-1 by referring to entries 91-1, 91-2, . . . , 91-n of the resource management table 90 (step 502), and issues a resource exchange request to the active OS 100-2 according to a target system to change in abnormal status specified in the resource management table 90 (step 503). Upon receipt of the request, the standby OS 100-2 attaches the added resource into OS resources by calling the resource engaging routine 140-2 (step 504), and reports the completion of attaching the resource to the virtual machine monitor 200 (step 505). Upon receipt of the report, the virtual machine monitor 200 updates owners of the entries 91-1, 91-2, . . . , 91-n of the resource management table 90 (step 506), and requests the standby OS 100-2 to start the application program A400-2 in the areas where application programs were operating (step 507). Thereby, the standby OS 100-2 can execute the application program A400-2 with sufficient resources.

In this embodiment, the resource engaging routine 140-2 of the active OS 100-2 indicates that the amount of main storage available to the operating system has increased, and can be realized by enabling main storage addresses having been so far disabled.

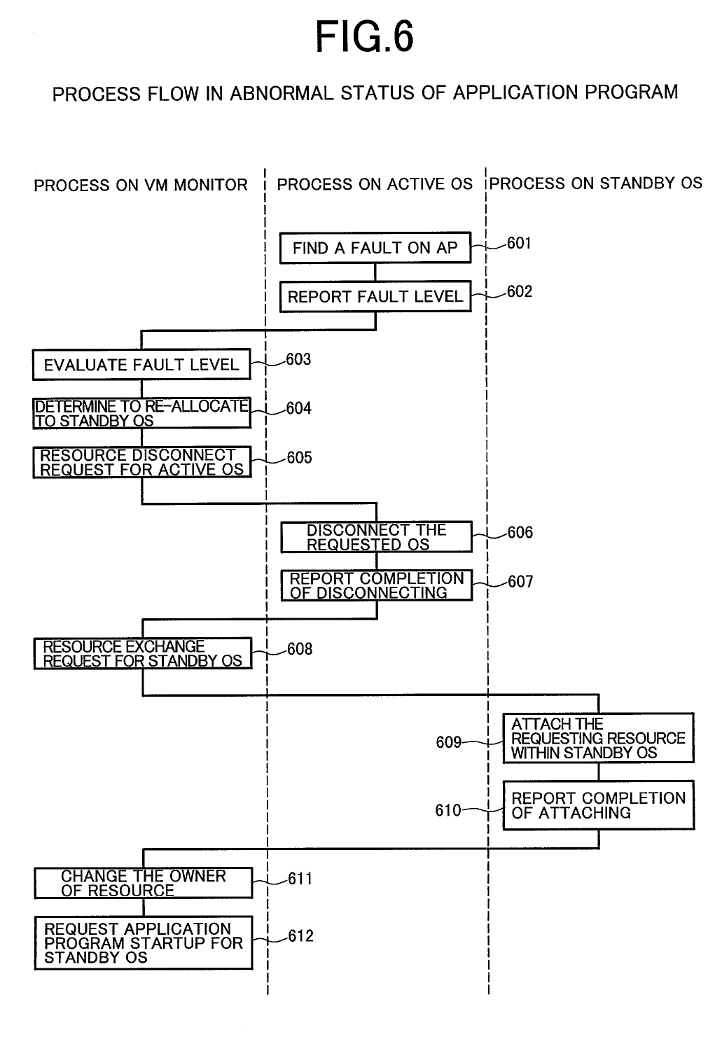

Next, referring to FIG. 6, the fault level notification routine 120-1 and the resource disconnection routine 130-1 are described using, as an example, a processing flow when only the application program A400-1 operating on the active OS 100-1 fails. The active OS 100-1 detects a fault of the application program A400-1 (step 601), and reports a fault level of the application program to the virtual machine monitor 200 (step 602).

The virtual machine monitor 200 evaluates the fault level (step 603), determines where to reallocate a resource owned by the application program A400-1 by referring to entries 91-1, 91-2, . . . , 91-n of the resource management table 90 (step 604), and requests the active OS 100-1 to disconnect a resource used by the application program A400-1 (step 605).

The active OS 100-1 calls the resource disconnection routine 130-1 to disconnect the resource (step 606) and reports the completion of disconnecting the resource to the virtual machine monitor 200 (step 607).

The virtual machine monitor 200, by referring to entries 91-1, 91-2, . . . , 91-n of the resource management table 90, and issues a resource exchange request to the standby OS 100-2 according to a target system to change in abnormal status of the application program A400-1 (step 608).

Upon receipt of the request, the standby OS 100-2 attaches the added resource to OS resources by calling the resource engaging routine 140-2 (step 609), and reports the completion of attaching the resource to the virtual machine monitor 200 (step 610).

Upon receipt of the report, the virtual machine monitor 200 updates owners of the entries 91-1, 91-2, . . . , 91-n of the resource management table 90 (step 611), and requests the standby OS 100-2 to start the application program A400-2 in the area where the application program was operating (step 612).

In the determination of a fault level of the application program A400-1 in the virtual machine monitor 200, for minor faults from which the active OS 100-1 can recover by itself, resources are not reallocated and the application program is restarted. Even for minor faults from which the active OS 100-1 can recover by itself, if fault recovery by the active OS 100-1 is difficult, the application program can be restarted in a short time by switching to the active OS 100-2.

In this way, according to the present embodiment, a virtual machine system can be provided which can dynamically reallocate resources among plural operating systems. Also, a virtual machine system can be provided which can dynamically reallocate resources in units of application programs.

Furthermore, a virtual machine system can be provided which, where such a serious fault as to disable access to an area used by the active OS 100-1 occurs, by reserving a small unused area in the virtual machine monitor 200, can restart the application program on the standby OS by disconnecting a part of the disabled resource and adding a part of the unused area.

Furthermore, a virtual machine system can be provided which, where the computer system can dynamically add resources, by temporarily holding resources in the virtual machine monitor, can add the computer resources without stopping hot standby operation.

According to the present invention, resources of a virtual machine system can be distributed among operating systems, so that resources required in the virtual machine system can be decreased.

What is claimed is:

1. A method of allocating computer resources in a virtual machine system, comprising the steps of:
providing an active VM and a standby VM;
allocating a main storage area sufficient to execute a certain application program to the active VM and a small main storage area insufficient to execute the application program to the standby VM; and
when a fault occurs in the active VM, attaching a part or all of the main storage area allocated to the active VM to the standby VM.

2. The method of allocating computer resources in the virtual machine system according to claim 1, further comprising the steps of:
providing a hot standby application program performing the same application as the certain application program in an auxiliary memory; and
when a fault occurs in the active VM, attaching a main storage area allocated to the certain program to the standby VM, and executing the hot standby application program using the main storage allocated to the OS of the standby VM.

3. The method of allocating computer resources in the virtual machine system according to claim 1,
wherein the virtual machine system has a virtual machine monitor to control plural OSs, which provides a resource management table which contains the respective use amounts of main storage for each of OSs, the virtual machine monitor, application programs, and unused areas; OSs or virtual machine monitor that uses the areas; and OSs or virtual machine monitor as target systems to change in abnormal status; and
wherein the virtual machine monitor, when a fault occurs in the active VM, refers to the resource management table and issues a request to attach the use amount of a required main storage area to a recorded target system to change in abnormal status.

4. A method of allocating computer resources in a virtual machine system, comprising the steps of:
providing an active OS and a standby OS; and
recording uses of main storage allocated to the active OS;
when a fault occurs in an application program operating on the active OS, referring to the recorded uses and reallocating main storage used by the failing application program to the standby OS, thereby executing an application program performing the same application as the application program that failed in the active OS.

5. A method of allocating computer resources in a virtual machine system having a virtual machine monitor controlling plural OSs,
wherein an active OS calculates computer resources used for execution of one or more application programs, including an application program of a hot standby job in which a program performing a same application is executed under the standby OS when a fault occurs, and if resources are sufficient, notifies the virtual machine monitor of which application program is using which resource; if resources are insufficient, obtains a new resource from the virtual machine monitor; and
wherein, when a fault occurs in an application program of the active OS or the hot standby job, the virtual machine monitor issues to the standby OS a request to attach a resource having being used by the application program of at least the hot standby job to the standby OS.

6. A method of allocating computer resources in a virtual machine system, for exclusively executing plural programs performing same applications by using a single computer system which has plural OSs, a virtual machine monitor controlling the plural OSs, and resources including main storage,
wherein a first OS of the plural OSs reports a resource allocated to a first application program operating on the first OS to the virtual machine monitor, and upon detecting a fault of the first application program, reports the fact to the virtual machine monitor;
wherein, upon receipt of a fault detection report from the first OS, the virtual machine monitor disconnects the resource having been used by the first application program from the first OS, allocates the resource to a second OS, and requests the second OS to initiate a second application program performing the same application as the first application program; and
wherein the second OS allocates a resource used by the second application program when initiated, from the allocated resource.

7. A method of allocating computer resources in a virtual machine system, for exclusively executing plural programs performing same applications by using a single computer system which has plural OSs, a virtual machine monitor controlling the plural OSs, and resources including main storage,
wherein a first OS of the plural OSs reports a resource allocated to a first application program operating on the first OS to the virtual machine monitor;
wherein, upon detecting a fault of the first OS, the virtual machine monitor allocates a part or all of resources having been used by the first OS to a second OS and requests the second OS to initiate a second application program performing the same application as the first application program; and
wherein the second OS allocates a resource used by the second application program when initiated, from the allocated resource.

8. A method of allocating computer resources in the virtual machine system according to claim 6, wherein, where the first OS and the second OS are in standby configuration, when a fault is detected in an application program operating on the first OS, a second application program is run on the second OS only when the failing application program is a hot standby job.

9. A virtual machine system which comprises an active OS, a standby OS, and a virtual machine monitor controlling plural OSs,
wherein the active OS includes at least: a fault level notification routine that monitors fault levels of application programs executed under the active OS, and when a fault is unrecoverable, reports the fact to the virtual machine monitor; and a resource disconnection routine that, upon receipt of a request to disconnect a resource allocated to the active OS from the virtual machine monitor, disconnects the requested resource;
wherein the standby OS includes a resource engaging routine that, upon receipt of a request to newly attach a resource from the virtual machine monitor, attaches the requested resource to that OS; and
wherein the virtual machine monitor includes: an OS fault detecting routine that detects a fault of the active OS; a means that, upon detecting a fault of the active OS, finds a resource to be reallocated to the standby OS and reports a resource to be newly attached to the standby OS; a means that, upon receipt, from the active OS, of notification that an application program is faulty, finds a resource to be disconnected and reports it to the active OS; and a means that, after completion of disconnecting the resource, reports a resource to be newly attached to the standby OS.
